(19) United States
(12) Patent Application Publication
(10) Pub. No.: US 2023/0402243 A1
(43) Pub. Date: Dec. 14, 2023

(54) PROTECTION ELEMENT WITH A COVER

(71) Applicant: CONQUER ELECTRONICS CO.,LTD., New Taipei City (TW)

(72) Inventors: Hung-Chih CHIU, New Taipei City (TW); Po-Shuo CHIU, New Taipei City (TW)

(21) Appl. No.: 17/857,632

(22) Filed: Jul. 5, 2022

(30) Foreign Application Priority Data
May 17, 2022 (TW) 111118418

(51) Int. Cl. H01H 85/055; H01H 85/165; H01H 85/143

(52) U.S. Cl. CPC H01H 85/055; H01H 85/143; H01H 85/165

(57) ABSTRACT

The present invention relates to a protection element having a cover. The protection element has a base and a cover. The base has a low melting point alloy layer. The cover has a receiving recess and a guiding passage. The guiding passage corresponds to a melting area of the low melting point alloy layer. The flux is arranged on the accommodating groove of the cover body. When the flux is melted, the flux flows to the guiding passage so that the flux is kept on the melting area of the low melting point alloy layer. Therefore, it is only necessary to place the flux in the receiving recess during manufacture, which can effectively reduce the manufacturing steps and thus reduce the production cost.

### CROSS-REFERENCE TO RELATED APPLICATIONS

This application is based upon and claims priority under 35 U.S.C. 119 from Taiwan Patent Application No. 111118418 filed on May 17, 2022, which is hereby specifically incorporated herein by this reference thereto.

### BACKGROUND OF THE INVENTION

### 1. Field of the Invention

The present disclosure relates to a protection element, especially to a protection element for connecting to the rest electrical elements in the circuit, and for supplying protection effect against the overcurrent.

### 2. Description of the Prior Arts

A power circuit usually has a protective element. When a power loop of the power circuit is abnormal, such as the overcurrent or the overvoltage is occurred, the protective element cuts off the power loop of the power circuit to protect the power circuit. The conventional protection element in accordance with the prior arts has a main body, a low melting point alloy layer and an electrode layer. The low melting point alloy layer is disposed on a main body. The electrode layer connects to the low melting point alloy layer. When a closed circuit is formed, a current pass the low melting point alloy layer through the electrode layer. When the overcurrent or the overvoltage is occurred, the low melting point alloy layer is melted because of overheating to protect the power circuit by opening the power circuit.

The low melting point alloy layer in accordance with the prior arts is usually coated by a flux. The flux not only assists in the melting of the low melting point alloy layer, but usually protects the low melting point alloy layer and prevents the low melting point alloy layer from oxidation. However, evenly coating the flux on the low melting point alloy layer is time-consuming and labor-intensive. Therefore, the conventional protection element in accordance with the prior arts needs to be improved.

### SUMMARY OF THE INVENTION

In view of the above, the present invention is to improve a structure of the protection element, and to evenly coat the flux on the low melting point alloy layer in a time-saving and an effortless way.

The main technical features used to achieve the objection as mentioned above is that the protection element with a cover includes:

a main body having
a base having a first surface and a second surface, wherein the base is made of an electrical insulating material;
an inner connection layer formed on the first surface of the base;
an outer connection layer formed on the second surface of the base and electrically connecting to the inner connection layer; and
a low melting point alloy layer disposed on the first surface of the base, and electrically connecting to the inner connection layer, and the low melting point alloy layer having
   at least one melting area adjacent to a connecting portion between the low melting point alloy layer and the inner connection layer;

a cover mounted on the main body having
an inner surface;
a receiving recess disposed on the inner surface; and
at least one guiding passage disposed on the inner surface and communicating with the receiving recess, each guiding passage corresponding to one of the melting areas of the low melting point alloy layer; and

a flux placed in the receiving recess of the cover, wherein when a temperature of the protection element increases, the flux melts and flows into the at least one guiding passage from the receiving recess so that the melted flux is correspondingly disposed on the at least one melting area of the low melting point alloy layer.

The present invention includes at least the advantages described below. When the flux is melted, the flux is kept on the melting area of the low melting point alloy layer by the design of the guiding passage and the receiving recess of the cover. Therefore, it is only necessary to place the flux in the receiving recess during manufacture, which can effectively reduce the manufacturing steps and thus reduce the production cost.

### BRIEF DESCRIPTION OF THE DRAWINGS

FIG. 1 is a perspective view of a protection element in accordance with the present invention;

FIG. 2 is an exploded perspective view of the protection element in FIG. 1;

FIG. 3 is a side view in partial section of a base of the protection element along the line A-A in FIG. 2;

FIG. 4 is a side view in partial section of the base of the protection element along the line B-B in FIG. 2;

FIG. 5 is another exploded perspective view of a cover of the protection element in FIG. 1;

FIG. 6 is an operational side view in partial section of the protection element in FIG. 1, showing a flux is not melted yet;

FIG. 7 is an operational side view in partial section of the protection element in FIG. 1, showing the flux is not melted yet;

FIG. 8 is an operational side view in partial section of the protection element in FIG. 1, showing the flux is melted;

FIG. 9 is an operational side view in partial section of the protection element in FIG. 1, showing the flux is melted;

FIG. 10 is a perspective view of the protection element in FIG. 1, showing the flux is melted and that a cover is shown transparent.

### DETAILED DESCRIPTION OF THE EMBODIMENTS

With reference to the attached drawings, the present invention is described by means of the embodiments below where the attached drawings are simplified for illustration purposes only to illustrate the structures or methods of the present invention by describing the relationships between the components and assembly in the present invention. Therefore, the components shown in the figures are not expressed with the actual numbers, actual shapes, or actual dimensions, nor with the actual ratio. Some of the dimensions or dimension ratios have been enlarged or simplified to provide a better illustration. The actual numbers, actual shapes, or actual dimension ratios can be selectively designed and disposed, and the detailed component layouts may be more complicated.

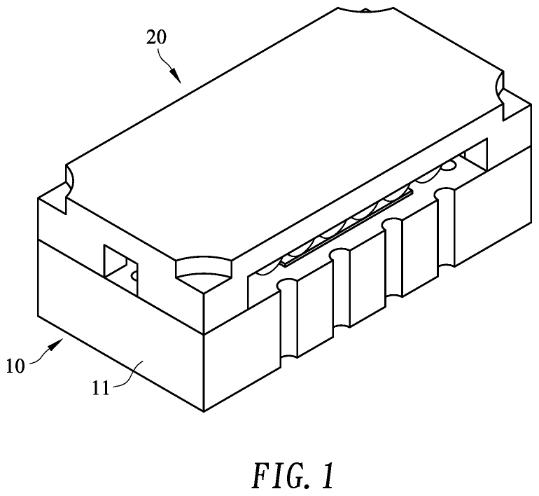

With reference to FIG. 1, a protection element in accordance with the present includes a main body 10 and a cover 20.

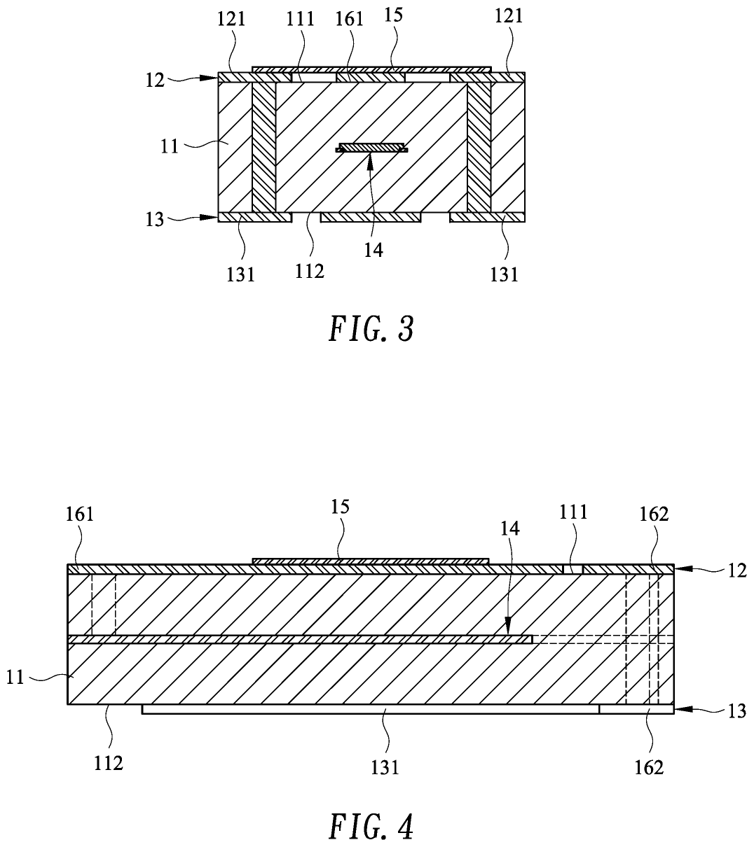

With reference to FIGS. 1 to 4, the main body 10 includes a base 11, an inner connection layer 12, an outer connection layer 13, a heating layer 14 and a low melting point alloy layer 15. The base 11 is made of a single electrical insulating material and has a first surface 111 and a second surface 112. The first surface 111 has two opposite long sides and the second surface 112 also has two opposite long sides. The inner connection layer 12 is formed on the first surface 111 of the base 11. The outer connection layer 13 is formed on the second surface 112 of the base 11 and electrically connects to an external power circuit. The heating layer 14 is mounted inside and encapsulated by the base 11 and electrically connects to the outer connection layer 13. The low melting point alloy layer 15 has at least one melting area 151. The low melting point alloy layer 15 is formed on the first surface 111 of the base 11 and electrically connects to the inner connection layer 12 and the heating layer 14. The melting area 151 is disposed on and adjacent to a connecting portion between the low melting point alloy layer 15 and the inner connection layer 12.

In one embodiment, the inner connection layer 12 includes two inner loop electrodes 121. The inner loop electrodes 121 are respectively disposed on and adjacent to the long sides of the first surface 111. The outer connection layer 13 includes two outer loop electrodes 131. The outer loop electrodes 131 are respectively disposed on and adjacent to the long sides of the second surface 112. The outer loop electrodes 131 respectively and electrically connect to the inner loop electrodes 121. The low melting point alloy layer 15 is mounted across the inner loop electrodes 121 and has two melting areas 151. The melting areas 151 are respectively disposed on and adjacent to the inner loop electrodes 121. When the outer connection layer 13 connects to the external power circuit through the outer loop electrodes 131, the current passes through the outer loop electrodes 131, the inner loop electrodes 121 and the low melting point alloy layer 15 to form a closed circuit.

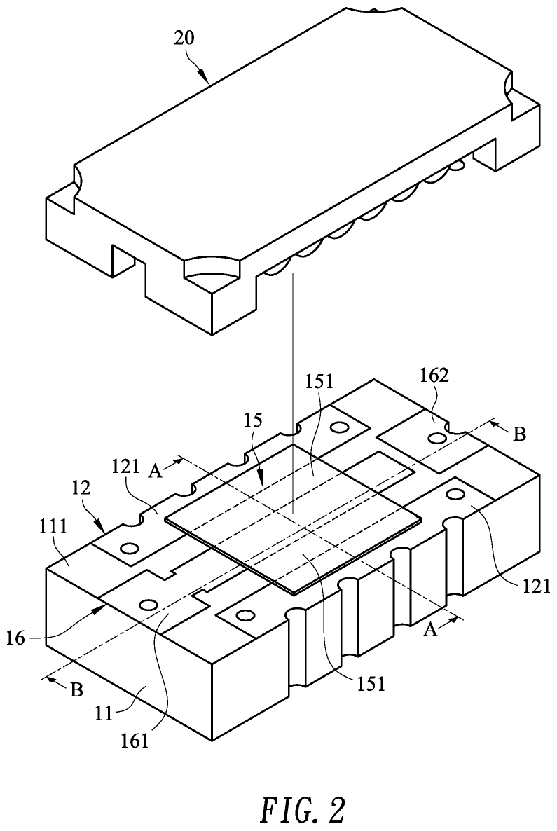

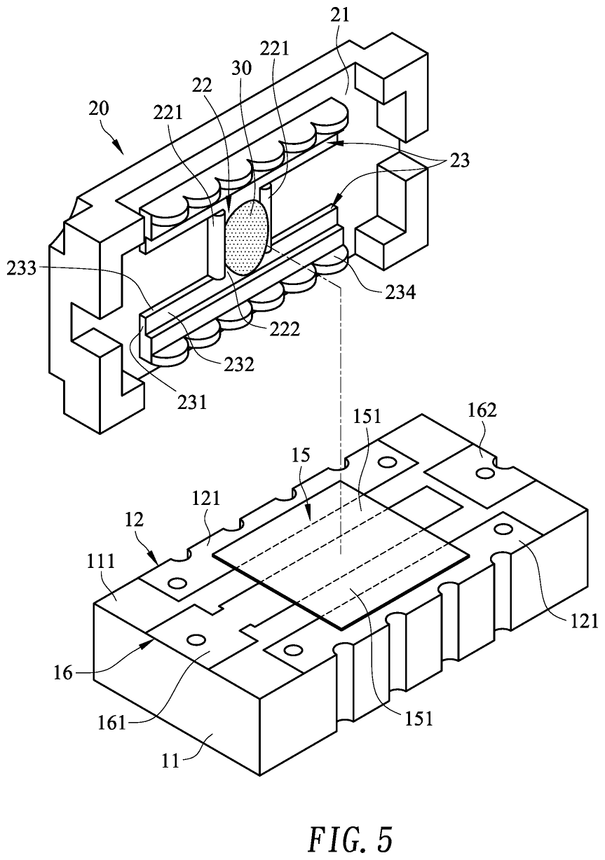

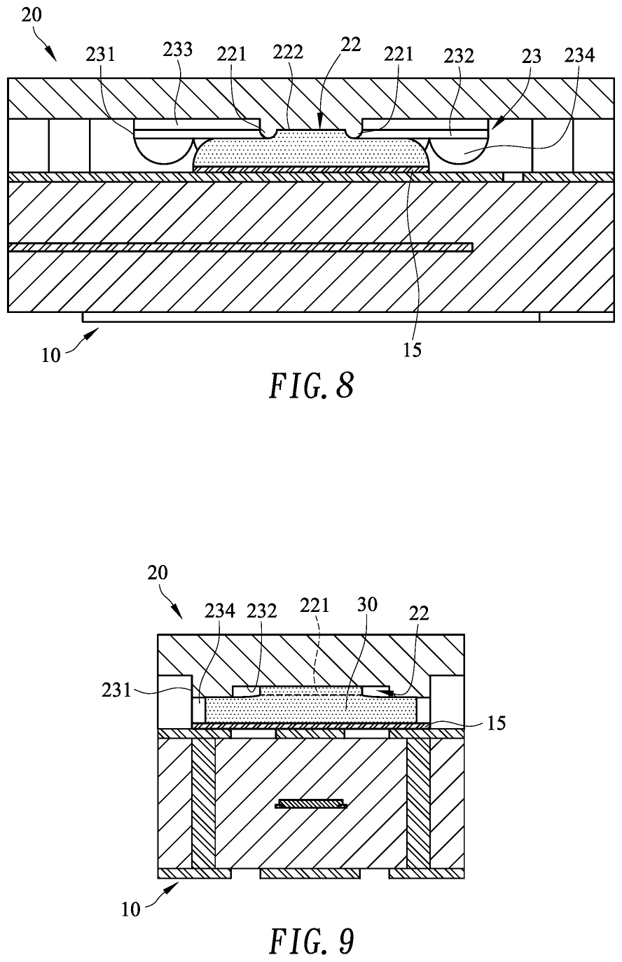

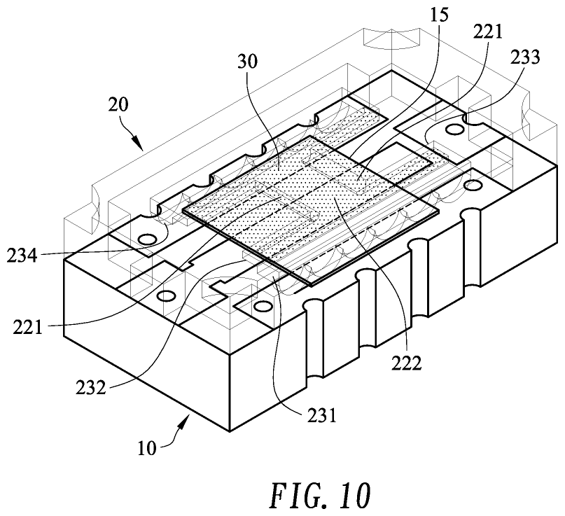

With reference to FIGS. 2 and 5 to 7, the cover 20 is mounted on the main body 10 and has an inner surface 21, a receiving recess 22 and at least one guiding passage 23. The receiving recess 22 and the guiding passage 23 are disposed on the inner surface 21. The receiving recess 22 communicates with the guiding passage 23. Each guiding passage 23 corresponds to one of the melting areas 151 of the low melting point alloy layer 15. A flux 30 is placed in the receiving recess 22, and the flux 30 is a high-viscosity substance. When the overall temperature of the protection element increases due to the current, the flux 30 melts (as shown in FIGS. 8 to 10) and flows into the guiding passage 23 from the receiving recess 22 because of the siphon principle. Therefore, the flux 30 is naturally disposed on the melting area 151 to protect the low melting point alloy layer 15 and easily helps to speed up the the fusion of the melting area 151. In one embodiment, the cover 20 has two guiding passages 23, the guiding passages 23 are respectively disposed on both sides of the receiving recess 22. Each guiding passage 23 corresponds to one of the melting areas 151. The guiding passages 23 are parallel with each other and perpendicular to the receiving recess 22. A length of each guiding passage 23 is greater than a length of the receiving recess 22.

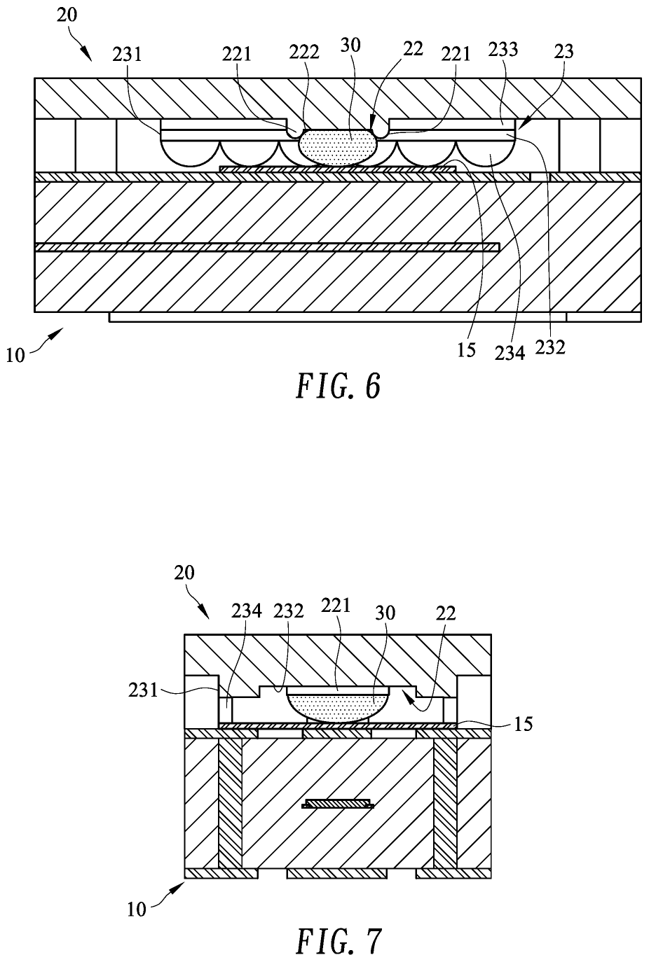

In one embodiment, the receiving recess 22 is defined by two sidewalls 221 and a receiving space 222. Each sidewall 221 has two ends. The receiving space 222 has two sides. The sidewalls 221 are respectively disposed on the sides of the receiving space 222. Each guiding passage 23 has a rib 231, the ribs 231 are perpendicularly disposed on one of the ends of the sidewalls 221. Each rib 231 has a ladder 232 and a low wall 233. Each ladder 232 is composed of continuous indentations with different thicknesses. The low walls 233 of the ribs 231 are adjacent to the receiving space 222 of the receiving recess 22. A thickness of each low wall 233 is smaller than a thickness of each sidewall 221. Each ladder 232 is adjacent to and communicates with the receiving space 222 of the receiving recess 22. One side of each ladder 232 has a long side wall 234 far from the receiving space 222. With reference to FIGS. 6 and 7, when the flux 30 is placed, the sidewalls 221 and the receiving space 222 hold the flux 30 in position and keep an initial position of the flux 30. With reference to FIGS. 8 to 10, when the flux 30 melts and flows into the ladders 232 from the receiving space 222, the long side walls 234 effectively guide the flux 30. Therefore, the flux 30 is kept on the melting area 151 of the low melting point alloy layer 15. In one embodiment, a lower edge of each long side wall 234 may be a wavy arc shape. Thus, the lower edges of the long side walls 234 prevent the low melting point alloy layer 15 from damaged when the long side walls 234 are close to the low melting point alloy layer 15.

When the external power circuit is turned on, the current is conducted from the outer connection layer 13 and passes through the inner connection layer 12 and the low melting point alloy layer 15. Because the melting area 151 is adjacent to the connecting portion between the low melting point alloy layer and the inner connection layer 12, the temperature of the melting area 151 increases first in reacting to a risen temperature of a circuit when an overcurrent is occurred. The flux 30 is effectively kept on the melting area 151 of the low melting point alloy layer 15 through the guiding passage 23. Thus, the flux 30 easily helps to speed up the fusion of the melting area 151 of the low melting point alloy layer 15 and achieves an opened circuit rapidly to protect the external power circuit.

In one embodiment, as shown in FIGS. 2 to 4, the heating layer 14 electrically connects to a thermal electrode unit 16. The thermal electrode unit 16 electrically connects to the outer connection layer 13 and the low melting point alloy layer 15 to conduct the current from the external power circuit to pass through the heating layer 14. Thus, the heating layer 14 is heated by the current to accumulate the heat in the heating layer 14 mounted inside the base 11. Then the heat is conducted to the low melting point alloy layer 15 to help to speed up the fusion of the low melting point alloy layer 15 because of the effect of overheating. In one embodiment, the thermal electrode unit 16 has an inner thermal electrode 161 and two outer thermal electrodes 162. The inner thermal electrode 161 is disposed on the first surface 111 of the base 11 and overlaid with the low melting point alloy layer 15. The inner thermal electrode 161 electrically connects to the heating layer 14 and the low melting point alloy layer 15. The outer thermal electrodes 162 are respectively disposed on the first surface 111 and the second surface 112 of the base 11. In another embodiment, the thermal electrode unit 16 only has one outer thermal electrode 162 disposed on the second surface 112 of the base 11. The outer thermal electrodes 162 respectively connect to the heating layer 14 and the outer connection layer 13. Therefore, the current from the external power circuit is conducted to the heating layer 14 through the outer connection layer 13. Thus, the outer thermal electrode 162, the heating layer 14, the inner thermal electrode 161 and the low melting point alloy layer 15 form a heating loop.

In one embodiment, a plurality of conductive vias are formed in the base 11 to achieve an electrical connection between the outer loop electrode 131 and the inner loop electrode 121, an electrical connection between the inner thermal electrode 161 and the heating layer 14, and an electrical connection between the outer thermal electrode 162, the outer connection layer 13 and the heating layer 14.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A protection element comprising:
a main body having
a base having a first surface and a second surface, wherein the base is made of an electrical insulating material;
an inner connection layer formed on the first surface of the base;
an outer connection layer formed on the second surface of the base and electrically connecting to the inner connection layer; and
a low melting point alloy layer formed on the first surface of the base and electrically connecting to the inner connection layer, and the low melting point alloy layer having
at least one melting area disposed on and adjacent to a connecting portion between the low melting point alloy layer and the inner connection layer;
a cover mounted on the main body having
an inner surface;
a receiving recess disposed on the inner surface; and
at least one guiding passage disposed on the inner surface and communicating with the receiving recess, and each of the at least one guiding passage corresponding to one of the at least one melting area of the low melting point alloy layer; and
a flux placed in the receiving recess of the cover, wherein when a temperature of the protection element increases, the flux melts and flows into the at least one guiding passage from the receiving recess so that the melted flux is correspondingly disposed on the at least one melting area of the low melting point alloy layer.

2. The protection element as claimed in claim 1, wherein the amount of the at least one guiding passage is two, and the two guiding passages are respectively disposed on both sides of the receiving recess.

3. The protection element as claimed in claim 2, wherein the guiding passages are parallel with each other and perpendicular to the receiving recess.

4. The protection element as claimed in claim 3, wherein
the receiving recess is defined by two sidewalls and a receiving space;
the receiving space has two sides;
the sidewalls are respectively disposed on the sides of the receiving space and each sidewall has two ends;
each of the guiding passages has a rib perpendicularly disposed on one of the ends of the sidewalls; and
each rib has a ladder adjacent to and communicating with the receiving space of the receiving recess, and one side of each ladder has a long side wall far from the receiving recess of the receiving recess.

5. The protection element as claimed in claim 4, wherein each rib has a low wall adjacent to the sidewall, and a thickness of each low wall is smaller than a thickness of each sidewall.

6. The protection element as claimed in claim 1 further having a heating layer mounted inside and encapsulated by the base and electrically connecting to the outer connection layer and the low melting point alloy layer.

7. The protection element as claimed in claim 2 further having a heating layer mounted inside and encapsulated by the base and electrically connecting to the outer connection layer and the low melting point alloy layer.

8. The protection element as claimed in claim 3 further having a heating layer mounted inside and encapsulated by the base and electrically connecting to the outer connection layer and the low melting point alloy layer.

9. The protection element as claimed in claim 4 further having a heating layer mounted inside and encapsulated by the base and electrically connecting to the outer connection layer and the low melting point alloy layer.

10. The protection element as claimed in claim 6 further having a thermal electrode unit electrically connecting to the heating layer, the outer connection layer, and the low melting point alloy layer, wherein the heating layer electrically connects to the outer connection layer and the low melting point alloy layer through the thermal electrode layer.

11. The protection element as claimed in claim 7 further having a thermal electrode unit electrically connecting to the heating layer, the outer connection layer, and the low melting point alloy layer, wherein
the heating layer electrically connects to the outer connection layer and the low melting point alloy layer through the thermal electrode layer.

12. The protection element as claimed in claim 8 further having a thermal electrode unit electrically connecting to the heating layer, the outer connection layer, and the low melting point alloy layer, wherein
the heating layer electrically connects to the outer connection layer and the low melting point alloy layer through the thermal electrode layer.

13. The protection element as claimed in claim 9 further having a thermal electrode unit electrically connecting to the heating layer, the outer connection layer, and the low melting point alloy layer, wherein
the heating layer electrically connects to the outer connection layer and the low melting point alloy layer through the thermal electrode layer.

14. The protection element as claimed in claim 10, wherein the thermal electrode unit has
an inner thermal electrode disposed on the first surface of the base and overlaid with the low melting point alloy layer and electrically connects to the heating layer and the low melting point alloy layer; and
an outer thermal electrode disposed on the second surface of the base and electrically connecting to the heating layer and the outer connection layer.

15. The protection element as claimed in claim 11, wherein the thermal electrode unit has
an inner thermal electrode disposed on the first surface of the base and overlaid with the low melting point alloy layer and electrically connects to the heating layer and the low melting point alloy layer; and
an outer thermal electrode disposed on the second surface of the base and electrically connecting to the heating layer and the outer connection layer.

16. The protection element as claimed in claim 12, wherein the thermal electrode unit has
an inner thermal electrode disposed on the first surface of the base and overlaid with the low melting point alloy layer and electrically connects to the heating layer and the low melting point alloy layer; and
an outer thermal electrode disposed on the second surface of the base and electrically connecting to the heating layer and the outer connection layer.

17. The protection element as claimed in claim 1, wherein
the first surface of the base has two long sides;
the second surface of the base has two long sides;
the inner connection layer has two inner loop electrodes respectively disposed on and adjacent to the long sides of the first surface of the base;
the outer connection layer has two outer loop electrodes respectively disposed on and adjacent to the long sides of the second surface of the base and respectively and electrically connecting to the inner loop electrodes;
the low melting point alloy layer is mounted across the inner loop electrodes; and
the amount of the at least one melting area is two and the melting areas are respectively disposed on and adjacent to the inner loop electrodes.

18. The protection element as claimed in claim 2, wherein
the first surface of the base has two long sides;
the second surface of the base has two long sides;
the inner connection layer has two inner loop electrodes respectively disposed on and adjacent to the long sides of the first surface of the base;
the outer connection layer has two outer loop electrodes respectively disposed on and adjacent to the long sides of the second surface of the base and respectively and electrically connecting to the inner loop electrodes;
the low melting point alloy layer is mounted across the inner loop electrodes; and
the amount of the at least one melting area is two and the melting areas are respectively disposed on and adjacent to the inner loop electrodes.

19. The protection element as claimed in claim 3, wherein
the first surface of the base has two long sides;
the second surface of the base has two long sides;
the inner connection layer has two inner loop electrodes respectively disposed on and adjacent to the long sides of the first surface of the base;
the outer connection layer has two outer loop electrodes respectively disposed on and adjacent to the long sides of the second surface of the base and respectively and electrically connecting to the inner loop electrodes;
the low melting point alloy layer is mounted across the inner loop electrodes; and
the amount of the at least one melting area is two and the melting areas are respectively disposed on and adjacent to the inner loop electrodes.

20. The protection element as claimed in claim 4, wherein
the first surface of the base has two long sides;
the second surface of the base has two long sides;
the inner connection layer has two inner loop electrodes respectively disposed on and adjacent to the long sides of the first surface of the base;
the outer connection layer has two outer loop electrodes respectively disposed on and adjacent to the long sides of the second surface of the base and respectively and electrically connecting to the inner loop electrodes;
the low melting point alloy layer is mounted across the inner loop electrodes; and
the amount of the at least one melting area is two and the melting areas are respectively disposed on and adjacent to the inner loop electrodes.
